(19) United States
(12) Patent Application Publication
(10) Pub. No.: US 2021/0246616 A1
(43) Pub. Date: Aug. 12, 2021

(54) GLASS FIBER FOR ROAD REINFORCEMENT

(71) Applicant: OCV Intellectual Capital, LLC, Toledo, OH (US)

(72) Inventors: Luc Brandt, Henri-Chapelle (BE); Patrick Moireau, Curienne (FR); Pauline Gachet Guillot, Allonzier La Caille (FR); Patrick Didierjean, Saint-Baldoph (FR)

(21) Appl. No.: 16/973,931

(22) PCT Filed: Jul. 1, 2019
(86) PCT No.: PCT/US19/40047

§ 371 Date: Dec. 10, 2020

Related U.S. Application Data
(60) Provisional application No. 62/695,318, filed on Jul. 9, 2018.

(51) Int. Cl. E01C 11/00; E01C 19/20; E01C 19/21; E01C 23/04; E01C 7/18; B29C 48/05; B29C 48/30

(52) U.S. Cl. CPC E01C 11/005; E01C 19/205; E01C 19/21; B29C 48/30; E01C 7/187; B29C 48/05; E01C 23/04

(57) ABSTRACT

A device for producing and applying a fibrous reinforcement material, such as a texturized strand material, as well as systems for and methods of reinforcing a road using the fibrous reinforcement material, are disclosed.

### RELATED APPLICATION

This application claims the benefit of U.S. Provisional Application No. 62/695,318 filed on Jul. 9, 2018, the content of which is incorporated by reference herein in its entirety.

### FIELD

The invention relates generally to the production of a fibrous reinforcement material and, more particularly, to systems for and methods of reinforcing a road using the fibrous reinforcement material.

### BACKGROUND

It is known to use chopped fibers in a process of building or repairing a road. For example, U.S. Pat. No. 7,448,826 to Laury (the entire disclosure of which is incorporated herein by reference) describes an automotive machine for chopping fibers and then spreading the chopped fibers, as well as a binder, on a roadway width. However, such an approach has many drawbacks. In general, chopping fibers in an environment involving asphalt deposition is problematic since the choppers will be exposed to contaminants and, thus, likely to require frequent maintenance. Furthermore, there is limited flexibility in application of the fibers, with both the width and the direction of application tied directly to the orientation of the machine.

It is also known to use a fibrous mat or fabric in a process of building or repairing a road. However, such an approach has many drawbacks. For example, it may be difficult to apply and/or position the mat, particularly if the roadway is curved or not substantially flat. Furthermore, there is limited flexibility in application of the fibers when using a pre-formed mat, with both the width and the direction of application locked into the mat configuration.

U.S. Pat. No. 5,976,453 to Nilsson et al. (the entire disclosure of which is incorporated herein by reference) describes a device and process for expanding a fibrous strand material into a wool-type product. The disclosed device is capable of expanding strand material into a wool-type product having a density of from about 30 g/L to about 69 g/L. Such low density wool-type products are desirable for use as sound absorbing material in engine exhaust mufflers, and as silencers for HVAC systems. The disclosed device is also capable of expanding strand material into a wool-type product having a density of from about 70 g/L to about 140 g/L. Such high density wool-type products are desirable for use as sound absorbing material in engine exhaust mufflers, and as silencers for HVAC systems. It is proposed to use such an expanded fibrous strand material (i.e., a texturized strand material) in a process of building or repairing a road.

In view of the above, the general inventive concepts provide improved systems for and methods of reinforcing a road using a fibrous reinforcement material.

### SUMMARY

The present invention relates to devices for producing and applying a fibrous reinforcement material, as well as to systems for and methods of reinforcing a road using the fibrous reinforcement material. In some exemplary embodiments, the fibrous reinforcement material is a texturized strand material.

The systems and methods of the present invention can extend the life of a road by increasing its resistance to crack formation and/or propagation through the use of a fibrous reinforcement material. In some exemplary embodiments, at least a portion of the fibers in the fibrous reinforcement material are glass fibers. In some exemplary embodiments, all of the fibers in the fibrous reinforcement material are glass fibers.

The systems and methods of the present invention are effective in applying the fibrous reinforcement material on curved and non-flat surfaces.

The systems and methods of the present invention are flexible in that a deposition width of the fibrous reinforcement material is readily adjustable.

The systems and methods of the present invention are flexible in that a deposition density (i.e., areal density) of the fibrous reinforcement material is readily adjustable.

The systems and methods of the present invention allow for the controlled placement of the fibrous reinforcement material, whether performed manually or in an automated manner.

In one exemplary embodiment, an apparatus is disclosed, the apparatus comprising a texturizing device having an input opening and an output opening; and an oscillator, wherein the texturizing device is operable to convert a strand of fibrous material fed through the input opening into a texturized fibrous material upon exiting through the output opening, and wherein the oscillator is operable to rotate the output opening such that the texturized fibrous material is deposited in a predetermined pattern.

In one exemplary embodiment, the apparatus further comprises a screen, wherein the screen is positioned to be in the path of the output opening such that the texturized fibrous material impacts the screen. In one exemplary embodiment, the screen has a plurality of perforations therein.

In one exemplary embodiment, the fibrous material comprises glass fibers. In one exemplary embodiment, the fibrous material consists of glass fibers.

In one exemplary embodiment, the texturized fibrous material has a density in the range of 40 g/L to 300 g/L.

In one exemplary embodiment, the texturized fibrous material has a texturization in the range of 20% to 85%.

In one exemplary embodiment, the texturized fibrous material has a width in the range of 30 mm to 200 mm.

In one exemplary embodiment, the pattern includes at least one non-linear portion. In one exemplary embodiment, the pattern is cyclic.

In one exemplary embodiment, an apparatus is disclosed, the apparatus comprising a body including a texturizing device having an input opening and an output opening; a nozzle interfaced with the output opening; and an oscillator, wherein the texturizing device is operable to convert a strand of fibrous material fed through the input opening into a texturized fibrous material upon exiting through the nozzle, and wherein the oscillator is operable to rotate the nozzle such that the texturized fibrous material is deposited in a predetermined pattern.

In one exemplary embodiment, the body further comprises a handle for holding the apparatus.

In one exemplary embodiment, the body further comprises a mount for mounting the apparatus to an automated applicator. In one exemplary embodiment, the automated applicator is an industrial robot.

In one exemplary embodiment, the body further comprises a mount for mounting the apparatus to a vehicle.

In one exemplary embodiment, the apparatus further comprises a screen, wherein the screen is fixed to the body and positioned to be in the path of the nozzle such that the texturized fibrous material impacts the screen. In one exemplary embodiment, the screen has a plurality of perforations therein.

In one exemplary embodiment, the apparatus further comprises a screen, wherein the screen is fixed to the nozzle and positioned to be in the path of the nozzle such that the texturized fibrous material impacts the screen, and wherein the screen rotates with the nozzle. In one exemplary embodiment, the screen has a plurality of perforations therein.

In one exemplary embodiment, the input opening and the output opening are coaxial with one another about an axis x, wherein the texturized fibrous material exits the nozzle at an angle θ relative to the axis x. In one exemplary embodiment, |θ|>15 degrees. In one exemplary embodiment, |θ|>30 degrees.

In one exemplary embodiment, the apparatus further comprises first logic for controlling the oscillator. In one exemplary embodiment, the first logic causes the oscillator to rotate in at least one of a clockwise direction and a counterclockwise direction. In one exemplary embodiment, the first logic controls a ratio of clockwise rotations of the nozzle to counterclockwise rotations of the nozzle. In one exemplary embodiment, the first logic varies a frequency at which the oscillator rotates the nozzle. In one exemplary embodiment, the first logic varies an amplitude at which the oscillator rotates the nozzle.

In one exemplary embodiment, the apparatus further comprises second logic for controlling a rate at which the fibrous material travels through the texturizing device. In one exemplary embodiment, the second logic varies the rate to achieve the pattern.

In one exemplary embodiment, the apparatus further comprises a source of compressed air for converting the strand of fibrous material to the texturized fibrous material; and third logic for controlling a pressure of the compressed air, wherein the third logic varies the pressure to achieve the pattern.

In one exemplary embodiment, an apparatus is disclosed, the apparatus comprising a body including a texturizing device having an input opening and an output opening; a nozzle interfaced with the output opening; a first channel; and a second channel, wherein the texturizing device is operable to convert a strand of fibrous material fed through the input opening into a texturized fibrous material upon exiting through the nozzle in a first direction of travel, wherein a first stream of air exits the first channel to impinge on the texturized fibrous material and causes the texturized fibrous material to assume a second direction of travel, and wherein a second stream of air exits the second channel to impinge on the texturized fibrous material and causes the texturized fibrous material to assume a third direction of travel.

In one exemplary embodiment, the nozzle is situated between the first channel and the second channel.

In one exemplary embodiment, the nozzle is equidistant from the first channel and the second channel.

In one exemplary embodiment, a pressure of the first stream of air is the same as a pressure of the second stream of air.

In one exemplary embodiment, a system for building or repairing a road is disclosed, the system comprising a vehicle and at least one of the aforementioned apparatuses moved by the vehicle along the dimensions of the road being built or the portion of the road being repaired.

In one exemplary embodiment, the system further comprises an applicator for applying a binder on the road being built or the portion of the road being repaired.

In one exemplary embodiment, a system for building or repairing a road is disclosed, the system comprising a vehicle; a plurality of any of the aforementioned apparatuses moved by the vehicle along the dimensions of the road being built or the portion of the road being repaired; and logic for independently controlling each of the apparatuses.

In one exemplary embodiment, the logic causes the apparatuses to deposit from 10 g/m² to 150 g/m² of the texturized fibrous material on the road being built or the portion of the road being repaired.

In one exemplary embodiment, the system further comprises at least one applicator for applying a binder on the road being built or the portion of the road being repaired. In one exemplary embodiment, the logic controls the applicator.

In one exemplary embodiment, the system further comprises a separate applicator for each of the apparatuses, wherein each applicator is operable to apply a binder on the road being built or the portion of the road being repaired. In one exemplary embodiment, the logic independently controls each applicator.

In one exemplary embodiment, the logic receives a current speed of the vehicle.

In one exemplary embodiment, the logic adjusts a speed of the vehicle.

In one exemplary embodiment, a first apparatus deposits the texturized fibrous material on the road being built or the portion of the road being repaired according to a first pattern, and a second apparatus deposits the texturized fibrous material on the road being built or the portion of the road being repaired according to a second pattern, wherein the first pattern has a deposition width L₁, and wherein the second pattern has a deposition width L₂. In one exemplary embodiment, L₁ is equal to L₂.

In one exemplary embodiment, the deposition width L₁ is separated from the deposition width L₂ by a gap, wherein the gap is free of any of the texturized fibrous material. In one exemplary embodiment, a width of the gap is less than L₁, and a width of the gap is less than L₂.

In one exemplary embodiment, the deposition width L₁ is directly adjacent to the deposition width L₂.

In one exemplary embodiment, at least a portion of the deposition width L₁ overlaps with at least a portion of the deposition width L₂. In one exemplary embodiment, none of the texturized fibrous material in the deposition width L₁ overlaps with any of the texturized fibrous material in the deposition width L₂.

In one exemplary embodiment, a system is disclosed, the system comprising a texturizing device having an input opening and an output opening; an oscillator; a first screen; and a second screen, wherein the texturizing device is operable to convert a strand of fibrous material fed through the input opening into a texturized fibrous material upon exiting through the output opening, wherein the oscillator is operable to redirect the texturized fibrous material such that the texturized fibrous material is deposited in a predetermined pattern, wherein the first screen is operable to be removably attached to at least one of the texturizing device and the oscillator so as to be positioned in the path of the output opening such that the texturized fibrous material impacts the first screen, wherein the second screen is operable to be removably attached to at least one of the texturizing device and the oscillator so as to be positioned in the path of the output opening such that the texturized fibrous material impacts the second screen, wherein the first screen has a plurality of first perforations therein, wherein the second screen has a plurality of second perforations therein, wherein a number and a shape of the first perforations define an open portion of the first screen, wherein a number and a shape of the second perforations define an open portion of the second screen, and wherein the open portion of the first screen is less than the open portion of the second screen.

In one exemplary embodiment, a method of building or repairing a road is disclosed, the method comprising providing a vehicle having at least one of any of the aforementioned apparatuses interfaced therewith; moving the vehicle along the dimensions of the road being built or the portion of the road being repaired; depositing the texturized fibrous material on the road being built or the portion of the road being repaired according to a predetermined pattern; applying a binder on the road being built or the portion of the road being repaired; and curing the binder. In one exemplary embodiment, the binder is asphalt.

In one exemplary embodiment, the method further comprises altering the pattern based on a change in the dimensions of the road being built or the portion of the road being repaired.

Other aspects, advantages, and features of the general inventive concepts will become apparent to those skilled in the art from the following detailed description, when read in light of the accompanying drawings.

### BRIEF DESCRIPTION OF THE DRAWINGS

For a fuller understanding of the nature and advantages of the general inventive concepts, reference should be had to the following detailed description taken in connection with the accompanying drawings, in which:

FIG. 1 illustrates a device for producing and applying a texturized strand material, according to an exemplary embodiment.

FIG. 2 illustrates a device for producing and applying a texturized strand material, according to another exemplary embodiment.

FIGS. 3A-3E illustrate a texturizing apparatus, according to one exemplary embodiment, for use in the devices of FIGS. 1-2. FIG. 3A is a perspective view of the texturizing apparatus. FIG. 3B is a front side elevational view of the texturizing apparatus. FIG. 3C is a rear side elevational view of the texturizing apparatus. FIG. 3D is a side elevational view in cross-section of the texturizing apparatus. FIG. 3E is a top plan view of the texturizing apparatus.

FIG. 4 is a perspective view of an inner nozzle section, according to one exemplary embodiment, for use in the texturizing apparatus of FIG. 3.

FIG. 5 is a perspective view of a spacing member (i.e., washer), according to one exemplary embodiment, for use in the texturizing apparatus of FIG. 3.

FIG. 6 is a perspective view of a piston, according to one exemplary embodiment, for use in the texturizing apparatus of FIG. 3.

FIGS. 7A-7E illustrate a seal holder, according to one exemplary embodiment, for use in the texturizing apparatus of FIG. 3. FIG. 7A is a perspective view of the seal holder. FIG. 7B is a side elevational view of the seal holder. FIG. 7C is a top plan view of the seal holder. FIG. 7D is a side elevational view in cross-section (along line A-A in FIG. 7C) of the seal holder. FIG. 7E is a side elevational view in cross-section (along line B-B in FIG. 7C) of the seal holder.

FIG. 8 is a perspective view of a cover, according to one exemplary embodiment, for use in the texturizing apparatus of FIG. 3.

FIGS. 9A-9D a device for producing and applying a texturized strand material, according to yet another exemplary embodiment.

FIG. 10 is a diagram showing a deposition pattern of a texturized strand material, according to an exemplary embodiment.

FIG. 11 is a diagram showing two adjacent instances of the deposition pattern of FIG. 10, wherein the patterns do not overlap and are in phase with one another.

FIG. 12 is a diagram showing two adjacent instances of the deposition pattern of FIG. 10, wherein the patterns overlap and are in phase with one another.

FIG. 13 is a diagram showing two adjacent instances of the deposition pattern of FIG. 10, wherein the patterns overlap and are not in phase with one another.

FIG. 14 is a diagram showing another deposition pattern of a texturized strand material, according to an exemplary embodiment.

FIG. 15 is a flowchart showing a method of reinforcing a road using a texturized strand material, according to an exemplary embodiment.

### DETAILED DESCRIPTION

While the general inventive concepts are susceptible of embodiment in many different forms, there are shown in the drawings and will be described herein in detail various exemplary embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used in the description of the general inventive concepts and the appended claims, the singular forms “a,” “an,” and “the” are intended to include the plural forms as well, unless the context clearly indicates otherwise.

Roadways typically degrade over time as a result of use and environmental exposure. Introduction of a texturized strand material formed from a fibrous feedstock (e.g., glass rovings) is proposed to extend the expected life of roads and repairs made therein. The mechanical properties of the texturized strand material (e.g., tensile strength) reinforce the roads and mitigate against crack formation and propagation. The texturized strand material is embedded in or otherwise interfaced with a binder (e.g., a bitumen binder) during road formation or repair. It is expected that the durability of a new road can be increased upwards of 50% by use of the texturized strand material. It is expected that the shelf life of a road repair can be increased upwards of 30% by use of the texturized strand material.

Any suitable reinforcing fibers (or combinations thereof) can be used, with glass being a preferred type of reinforcing fiber. As known in the art, glass reinforcing fibers typically have a chemistry applied thereon during formation of the fibers. This surface chemistry, often in an aqueous form, is called a sizing. The sizing can include components such as a film former, lubricant, compatibilizer, etc. that facilitate formation of the glass fibers and/or downstream use thereof. The particular sizing may assist in allowing the fibrous feedstock to be texturized and thereafter maintaining its volumized shape, even under moderate mechanical stress. In some exemplary embodiments, the sizing is at least one of a modified epoxy polymer, a polyvinyl acetate polymer, and a polyurethane polymer.

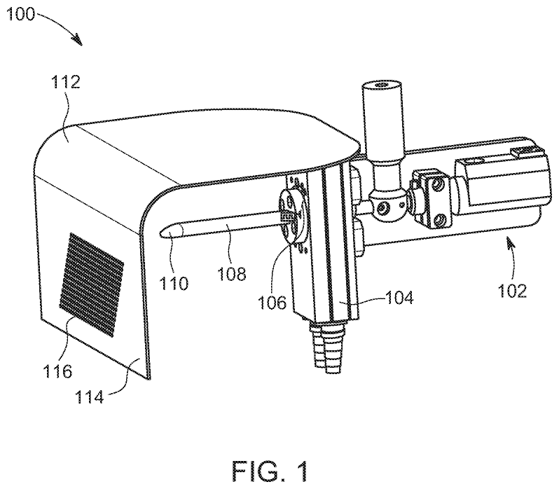

An apparatus 100 for applying a texturized strand material, according to an exemplary embodiment, is shown in FIG. 1. The apparatus 100 includes a texturizing device 102 (e.g., the texturizing device 300 described herein), a body 104, an oscillator 106, an output nozzle 108, and an output opening 110. The texturizing device 102 uses a source of compressed air to disrupt the integrity of a strand of fibrous material (e.g., a strand of glass fibers fed from a roving), so that the strand of fibrous material becomes a texturized strand material as it exits the output opening 110 of the output nozzle 108. In some exemplary embodiments, the output opening 110 is angled and/or shaped to convey the texturized strand material in a direction that differs from an axial direction of the output nozzle 108.

The oscillator 106 causes the output nozzle 108 (and, thus, the output opening 110) to rotate clockwise (CW) and/or counterclockwise (CCW), wherein these movements contribute to the distribution pattern of the texturized strand material. More particularly, the frequency of the oscillations, the amplitude of the oscillations, and the ratio of CW:CCW oscillations can all be varied to adjust the distribution pattern of the texturized strand material. Other processing parameters, such as the throughput of the fibrous material and the pressure of the air being pushed through the texturizing device 102, can also contribute to the distribution pattern of the texturized strand material. Consequently, the apparatus 100 provides for adjustable control of deposition of the texturized strand material on a desired surface (e.g., road). The body 104 can house internal aspects of the apparatus 100, such as the mechanism for driving the oscillator 106. In some exemplary embodiments, the body 104 could be formed into a handle for holding the apparatus 100. In some exemplary embodiments, the body 104 could be used to mount the apparatus 100 to some other structure (e.g., for automated application).

The apparatus 100 also includes a screen 112. The screen can be made of any suitable material, such as sheet metal. As shown in FIG. 1, the screen 112 is mounted on the body 104 and bends so that a portion 114 of the screen 112 is in the path of the texturized strand material existing the output opening 110. This portion 114 of the screen 112 includes a number of perforations 116. In this manner, the screen 112 acts as an air separator that allows a significant portion of the volume of air exiting the output opening 110 with the texturized strand material to pass through the perforations 116, while the texturized strand material impacts the screen 112 (i.e., doesn't pass through the perforations 116) and is allowed to fall to a desired location. The number, size, shape, and/or spacing of the perforations 116 can be selected based on the volume of air expected to be encountered. In some exemplary embodiments, different screens could be interchangeably used for different applications.

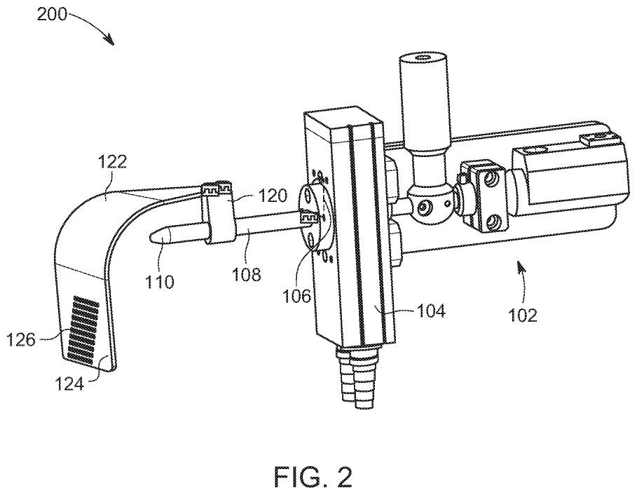

An apparatus 200 for applying a texturized strand material, according to another exemplary embodiment, is shown in FIG. 2. The apparatus 200 is similar to the apparatus 100 and, where appropriate, like reference numbers have been used to denote identical structure. The apparatus 200 includes a texturizing device 102 (e.g., the texturizing device 300 described herein), a body 104, an oscillator 106, an output nozzle 108, and an output opening 110. The texturizing device 102 uses a source of compressed air to disrupt the integrity of a strand of fibrous material (e.g., a strand of glass fibers fed from a roving), so that the strand of fibrous material becomes a texturized strand material as it exits the output opening 110 of the output nozzle 108. In some exemplary embodiments, the output opening 110 is angled and/or shaped to convey the texturized strand material in a direction that differs from an axial direction of the output nozzle 108.

The oscillator 106 causes the output nozzle 108 (and, thus, the output opening 110) to rotate clockwise (CW) and/or counterclockwise (CCW), wherein these movements contribute to the distribution pattern of the texturized strand material. More particularly, the frequency of the oscillations, the amplitude of the oscillations, and the ratio of CW:CCW oscillations can all be varied to adjust the distribution pattern of the texturized strand material. Other processing parameters, such as the throughput of the fibrous material and the pressure of the air being pushed through the texturizing device 102, can also contribute to the distribution pattern of the texturized strand material. Consequently, the apparatus 200 provides for adjustable control of deposition of the texturized strand material on a desired surface (e.g., road). The body 104 can house internal aspects of the apparatus 200, such as the mechanism for driving the oscillator 106. In some exemplary embodiments, the body 104 could be formed into a handle for holding the apparatus 200. In some exemplary embodiments, the body 104 could be used to mount the apparatus 200 to some other structure (e.g., for automated application).

The apparatus 200 also includes a screen 122. The screen can be made of any suitable material, such as sheet metal. While the screen 112 of the apparatus 100 was mounted on the body 104, the screen 122 of the apparatus 200 is mounted on the output nozzle 108. More specifically, as shown in FIG. 2, the screen 122 is mounted on an arm 120 that extends perpendicular to the output nozzle 108. In this manner, the screen 122 oscillates along with the output nozzle 108. Thus, while the screen 112 of the apparatus 100 needed to be large enough to encompass the entire oscillation range of its output nozzle 108, the screen 122 of the apparatus 200 can be much smaller as it need only accommodate the range of the output opening 110 of its output nozzle 108. The screen 122 bends so that a portion 124 of the screen 122 is in the path of the texturized strand material existing the output opening 110. This portion 124 of the screen 122 includes a number of perforations 126. In this manner, the screen 122 acts as an air separator that allows a significant portion of the volume of air exiting the output opening 110 with the texturized strand material to pass through the perforations 126, while the texturized strand material impacts the screen 122 (i.e., doesn't pass through the perforations 126) and is allowed to fall to a desired location. The number, size, shape, and/or spacing of the perforations 126 can be selected based on the volume of air expected to be encountered. In some exemplary embodiments, different screens could be interchangeably used for different applications.

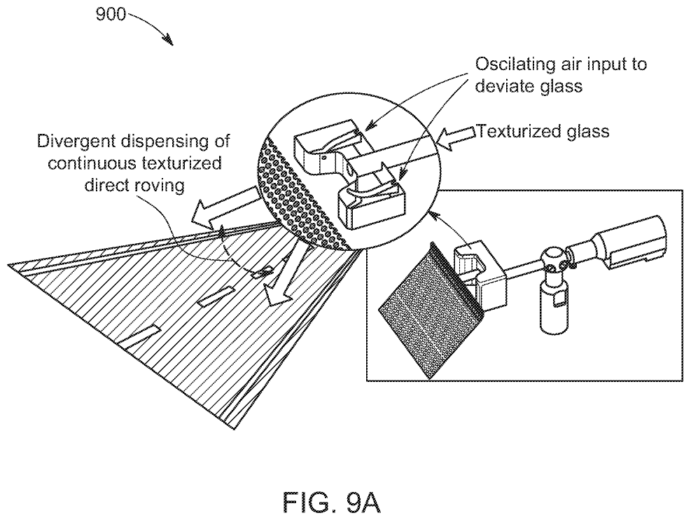

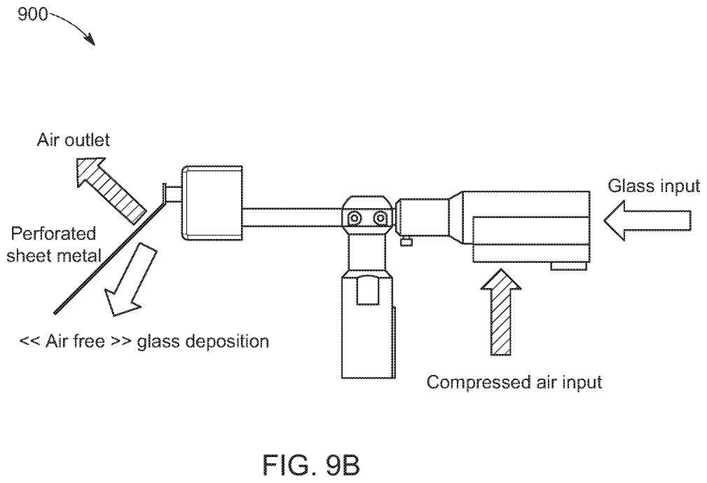

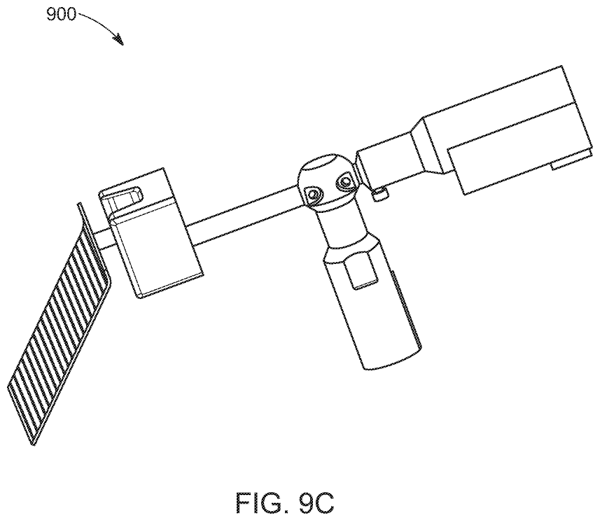

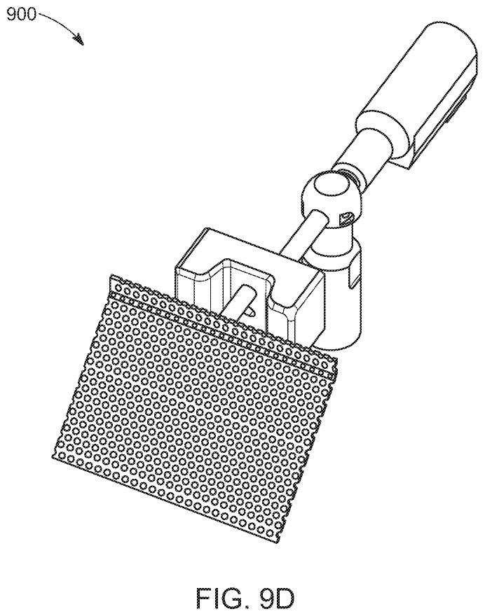

While the oscillator 106 in the exemplary embodiments of FIGS. 1 and 2 is a mechanical oscillator, other oscillating means could also be used. For example, as shown in FIGS. 9A-9D, an apparatus 900 uses alternating streams of air that impinge on a texturized strand material traveling in a fixed output direction, thereby causing the texturized strand material to travel in alternating directions. In some exemplary embodiments, the streams of air are provided by the same source of air used to texturize the fibrous strand material.

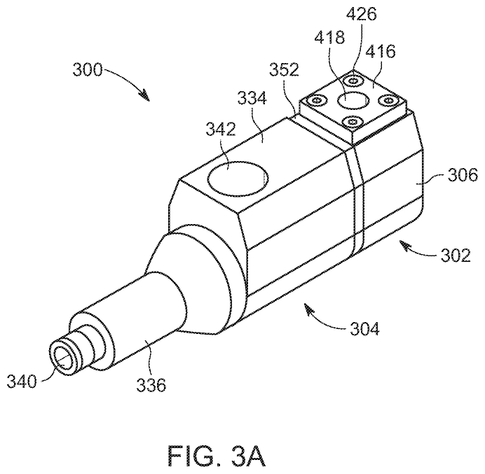

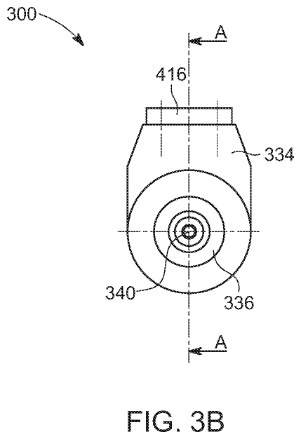

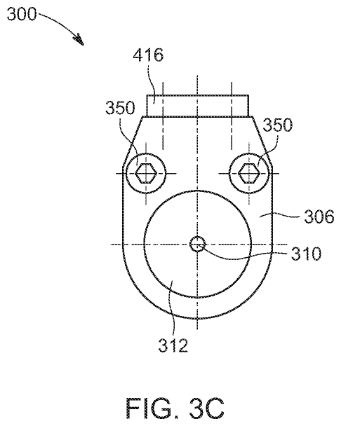

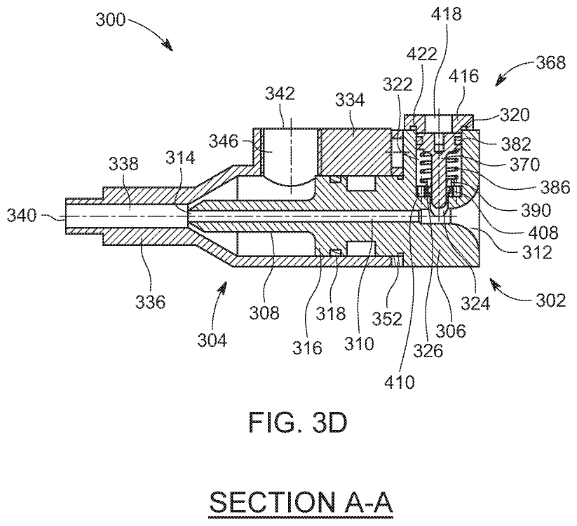

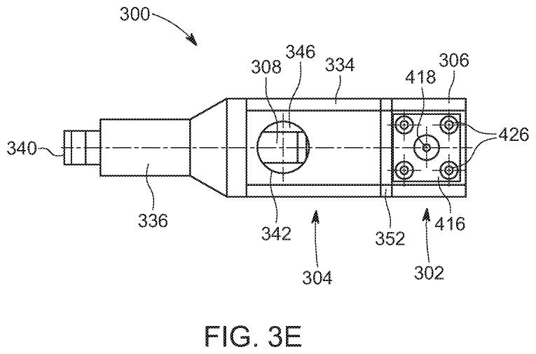

A texturizing device 300, according to one exemplary embodiment, is shown in FIGS. 3A-3E. The texturizing device 300 is being described to further illustrate the generation of texturized strand material from a fibrous strand material. The general inventive concepts are not intended to be limited to this specific texturizing device 300, as any device suitable to texturize a fibrous strand material into a wool-type product having a density in the range of 40 g/L to 300 g/L could be used. For example, U.S. Pat. No. 5,976,453 discloses a suitable texturizing device.

The texturizing device 300 produces a texturized strand material having a texturization in the range of 20% to 85%, as measured according to the ASTM C522 standard entitled “Airflow Resistance of Acoustical Materials.” A useful device for performing such measurements is disclosed in WIPO Publication No. WO 2017/127234, the entire disclosure of which is incorporated herein by reference.

The texturizing device 300 comprises an inner nozzle section 302 and an outer nozzle section 304. At least a portion of the inner nozzle section 302 is sized and/or shaped to fit inside or otherwise interface with at least a portion of the outer nozzle section 304 (see FIG. 3D).

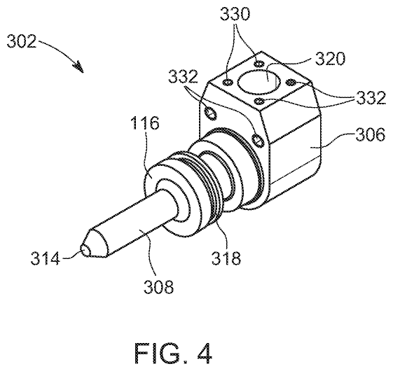

As shown in FIG. 4, the inner nozzle section 302 includes a main body 306 and a round, needle-like shaft 308 extending therefrom. A substantially linear first passage 310 for conveying a strand material extends through the main body 306 and the shaft 308. In particular, one end of the first passage 310 defines a strand inlet opening 312, while the opposite end of the first passage 310 defines a strand outlet opening 314.

The shaft 308 of the inner nozzle section 302 also includes a flange 316 housing a sealing member in the form of an O-ring 318 or the like. The O-ring 318 is operable to form an airtight seal between a portion of the inner nozzle section 302 positioned within the outer nozzle section 304 and an interior surface of the outer nozzle section 304 (see FIG. 3D). The flange 316 and its O-ring 318 are situated between the strand inlet opening 312 and the strand outlet opening 314.

The main body 306 of the inner nozzle section 302 includes a first bore 320 or other opening that extends from an upper surface of the main body 306 and into an inner cavity 322 of the main body 306. A floor of the inner cavity 322 includes an opening 324 therethrough which is smaller in size than the first bore 320. As a result, a shoulder 326 is formed at the floor of the inner cavity 322. The opening 324 in the floor of the inner cavity 322 connects the inner cavity 322 and the first passage 310.

A number of threaded holes 330 extend vertically down into the main body 306 (see FIG. 4). Here, vertically means substantially parallel to a central axis of the first bore 320. The holes 330 may be spaced around a circumference of the first bore 320 in any manner. In one exemplary embodiment, the holes 330 are spaced substantially evenly around a circumference of the first bore 320. In one exemplary embodiment, four holes 330 are formed in the main body 306. A number of threaded holes 332 extend horizontally into and through the main body 306. Here, horizontally means substantially parallel to a central axis of the shaft 308. In one exemplary embodiment, two holes 332 are formed in the main body 306. The purpose of the holes 330 and the holes 332 is described below.

As shown in FIGS. 3A and 3D, the outer nozzle section 304 includes a main body 334 and a nozzle end portion 336 extending therefrom. The first passage 310 of the inner nozzle section 302 ends at or near the start of the nozzle end portion 336 of the outer nozzle section 304 (see FIG. 3D). Thus, as the strand material exits the first passage 310 through the strand outlet opening 314 of the inner nozzle section 306, the strand material then enters into a second passage 338 formed in the nozzle end portion 336 of the outer nozzle section 304. Ultimately, the strand material exits the nozzle end portion 336 of the outer nozzle section 304 through a nozzle outlet 340. By this time, the strand material has been transformed from a strand of material into a texturized form of the material, such as a wool-type product.

In one exemplary embodiment, the reinforcement material is a continuous filament glass fiber (CFGF). The term “continuous filament glass fiber” as used herein shall mean a fiber formed from a plurality of continuous glass filaments. An example of such a fiber containing 4,000 filaments is commercially available in the form of a roving. Such glass fibers are suitable for many applications. For example, the glass fibers are well suited for reinforcement applications, owing to their mechanical properties. The glass fibers can be formed from any suitable glass. In one exemplary embodiment, the glass fibers are formed from E-glass or S-glass type fibers. As used herein, the term “strand material” has the same meaning as continuous glass filament fiber. The general inventive concepts also contemplate that the strand material may comprise basalt fibers or fibers formed of other materials. The general inventive concepts also contemplate that the strand material may comprise two or more different materials. The general inventive concepts also contemplate that the strand material may include a coating.

The main body 334 of the outer nozzle section 304 includes a second bore 342 that extends from an upper surface of the main body 334 and into an inner cavity 346 of the main body 334. The inner cavity 346 substantially surrounds the shaft 308 of the inner nozzle section 302. A source of pressurized fluid (e.g., air) can be connected to or otherwise interfaced with the second bore 342, such as by a fitting (not shown). In this manner, the texturizing device 300 can deliver the pressurized fluid so that it flows through the second bore 342, the inner cavity 346, the second passage 338, and out the nozzle outlet 340.

As known in the art, the strand material (not shown) is moved through the first passage 310 and the second passage 338 at least in part by application of the pressurized fluid (e.g., air) applied to the strand material upstream of the strand outlet opening 314. As also known in the art, the pressurized fluid acts to separate and expand the filaments, fibers, or the like comprising the strand material, thereby forming a texturized material (e.g., a wool-type product) which noticeably expands in apparent volume as it exits the texturizing device 300.

As noted above, at least a portion of the inner nozzle section 302 fits inside at least a portion of the outer nozzle section 304 (see FIG. 3A). Thereafter, fasteners or the like, such as screws 350, are inserted through (e.g., screwed into) the holes 332 in the main body 306 of the inner nozzle section 302 to engage corresponding holes (not shown) formed in the main body 334 of the outer nozzle section 304, thereby securing the inner nozzle section 302 and the outer nozzle section 304 to each other.

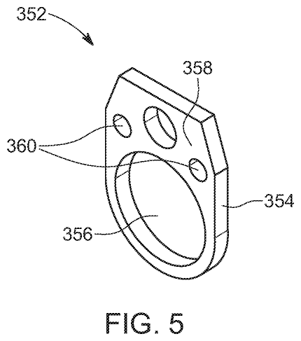

In one exemplary embodiment, a spacing member or similar structure, such as a washer 352 (see FIG. 5), is positioned between the inner nozzle section 302 and the outer nozzle section 304 prior to securing or otherwise fastening the inner nozzle section 302 and the outer nozzle section 304 together. The washer 352 includes a main body 354 having a central bore 356 or opening therethrough and a flange portion 358 adjacent the central bore 356. The flange portion 358 includes a pair of holes 360 that extend horizontally into and through the main body 354. Here, horizontally means substantially parallel to a central axis of the central bore 356.

The washer 352 facilitates proper spatial alignment, spacing, and the like between the inner nozzle section 302 and the outer nozzle section 304, as they are joined together. In one exemplary embodiment, the holes 360 in the washer 352 correspond to the holes 332 formed in the inner nozzle section 302 and the holes (not shown) formed in the outer nozzle section 304. In this manner, the screws 350 or other fasteners used to join the inner nozzle section 302 to the outer nozzle section 304 can also function to secure or otherwise hold the washer 352 in place.

As known in the art, the texturizing device 300 may include a cutting device or mechanism (not shown). The cutting device (i.e., cutter) is operable to cut or otherwise separate the continuous strand material (e.g., between filling operations or other use cycles).

It is also known in the art for a texturizing device, such as the texturizing device 300, to include a locking device or mechanism. The locking device is operable to selectively halt movement of the continuous strand material through the texturizing device 300 (e.g., through the passages 310 and 338).

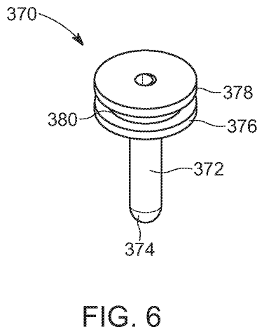

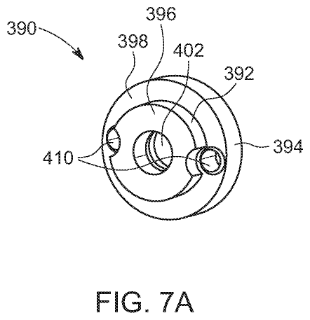

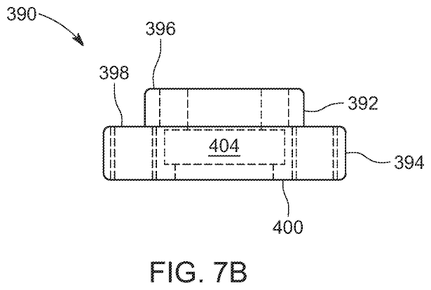

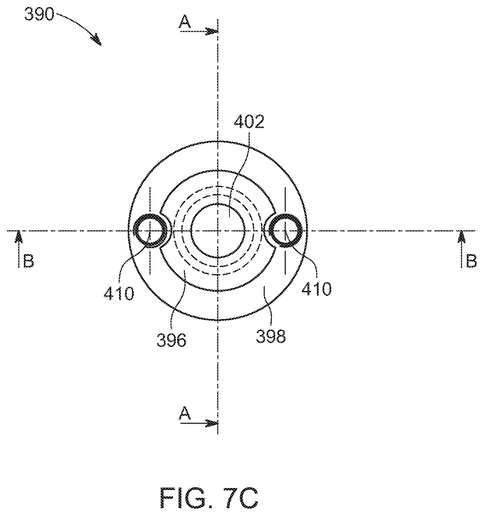

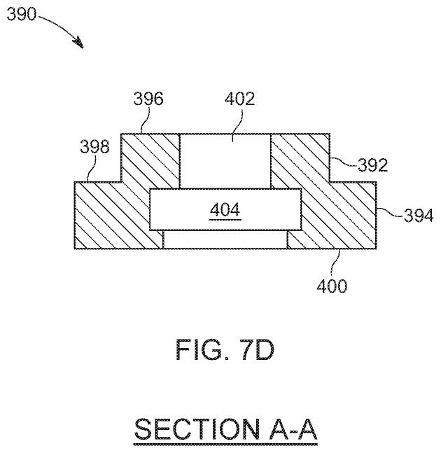

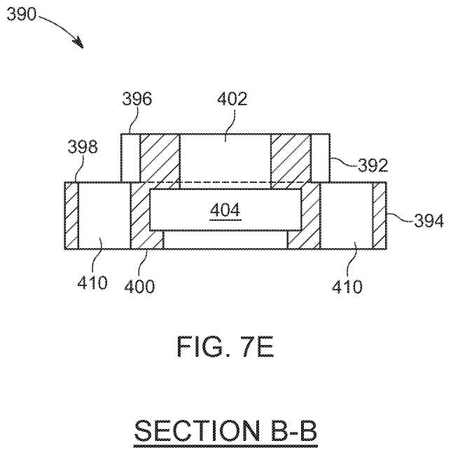

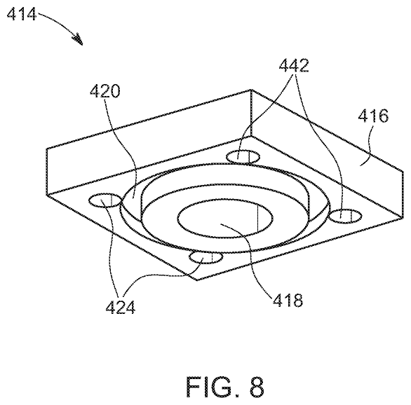

As best shown in FIG. 3D, the texturizing device 300 includes a locking device 368 coupled to the main body 306 of the inner nozzle section 302. In particular, the locking device 368 is primarily situated in the inner cavity 322 of the main body 306. The locking device 368 comprises a piston 370 (see FIG. 6), a compression spring 386 (see FIG. 3D) or other resilient member, a seal holder 390 (see FIGS. 7A-7E), and a cover 414 (see FIG. 8).

The piston 370 of the locking device 368 is shown in FIG. 6. The piston 370 includes a shaft 372. One end of the shaft 372 forms a nose 374 of the piston 370. In one exemplary embodiment, the nose 374 differs in size and/or shape from the shaft 372. In one exemplary embodiment, the nose 374 is tapered or rounded. The other end of the shaft 372 is connected to (or formed integrally with) a lower flange 376 of the piston 370. An upper flange 378 of the piston 370 is spaced from the lower flange 376 so as to form a channel 380. The channel 380 of the piston 370 is operable to receive, house, or otherwise interface with a sealing member in the form of an O-ring 382 or the like.

The seal holder 390 of the locking device 368 is shown in FIGS. 7A-7E. The seal holder 390 includes an upper main body 392 formed integrally with a lower main body 394. An upper surface of the upper main body 392 forms an upper ledge 396 of the seal holder 390. Because the upper main body 392 has a smaller circumference than the lower main body 394 (see FIG. 7A), a lower ledge 398 is formed where the upper main body 392 and the lower main body 394 meet. A lower surface of the lower main body 394 is the lower surface 400 of the seal holder 390. Thus, a height of the seal holder 390 is measured from the upper ledge 396 to the lower surface 400.

The seal holder 390 also includes a central opening 402 that extends through the upper main body 392 and the lower main body 394. As shown in FIGS. 7D-7E, a size (i.e., diameter) of the central opening 402 varies and is greatest between the upper ledge 396 and the lower surface 400, such that a seal cavity 404 is formed inside the seal holder 390. The seal cavity 404 is an annular space operable to receive, house, or otherwise interface with a sealing member in the form of an O-ring 408 or the like (see FIG. 3D). The size of the central opening 402 is sufficient large to allow the shaft 372 of the piston 370 to pass therethrough.

The seal holder 390 also includes a number of threaded holes 410 extending through the lower main body 394. In one exemplary embodiment, two holes 410 are formed in the lower main body 394 of the seal holder 390. In one exemplary embodiment, the holes 410 are evenly spaced around a circumference of the central opening 402 of the seal holder 390.

The holes 410 in the seal holder 390 correspond to holes (not shown) in the floor of the inner cavity 322 of the inner nozzle section 302. Thus, when the seal holder 390 is properly fit in the inner cavity 322, the lower surface 400 of the seal holder 390 comes to rest on the shoulder 326 of the main body 306. By manipulation (e.g., rotation) of the seal holder 390, the holes 410 in the seal holder 390 can be aligned with the holes in the floor of the inner cavity 322. Thereafter, fasteners or the like, such as screws (not shown), are inserted through (e.g., screwed into) the holes 410 in the seal holder 390 to engage the corresponding holes in the main body 306 of the inner nozzle section 302, thereby securing the seal holder 390 to the inner nozzle section 302.

The piston 370, the spring 386, and the seal holder 390 fit into the inner cavity 322 through the first bore 320 formed in the main body 306. Thereafter, the first bore 320 is sealed by the cover 414. The cover 414 attaches to or otherwise interfaces with the main body 306 to secure the piston 370, the spring 386, and the seal holder 390 within the inner cavity 322 of the inner nozzle section 302.

The cover 414 of the locking device 368 is shown in FIG. 8. The cover 414 includes a main body 416 with a central opening 418. An annular recess 420 is formed in the main body 416 and surrounds the central opening 418. The recess 420 of the cover 414 is operable to receive, house, or otherwise interface with a sealing member in the form of an O-ring 422 or the like (see FIG. 3D).

The main body 416 of the cover 414 is sized so as to completely occlude the first bore 320 of main body 306. When the cover 414 is properly fit on the main body 306, the central opening 418 of the cover 414 is aligned with or otherwise overlaps the first bore 320 in the main body 306.

The cover 414 also includes a number of threaded holes 424 extending through the main body 416. In one exemplary embodiment, four holes 424 are formed in the main body 416 of the cover 414. The holes 424 in the cover 414 correspond to the holes 330 in the main body 306 of the inner nozzle section 302. Thus, when the cover 414 is properly fit on the main body 306, the holes 424 and the holes 330 are aligned. Thereafter, fasteners or the like, such as screws 426, are inserted through (e.g., screwed into) the holes 424 in the main body 416 of the cover 414 to engage the corresponding holes 330 in the main body 306 of the inner nozzle section 302, thereby securing the cover 414 to the inner nozzle section 302 (see FIGS. 3A and 3E). The O-ring 422 allows for an airtight seal to be formed between the cover 414 and the main body 306 of the inner nozzle section 302, once the cover 414 is secured to the main body 306 (see FIG. 3D).

The piston 370 is sized and/or shaped so that it can reciprocate within the inner cavity 322. The O-ring 382 is operable to form an airtight seal between the piston 370 and an inner surface of the inner cavity 322. This airtight seal is maintained during reciprocation of the piston 370 within the inner cavity 322.

The spring 386 at least partially surrounds the shaft 372 of the piston 370. The spring 386 pushes against the lower flange 376 of the piston 370 to bias it toward the cover 414. In this manner, the normal tendency of the spring 386 is to urge the nose 374 of the piston 370 out of the first passage 310, so that the strand material may freely move through the first passage 310.

However, the normal tendency of the spring 386 may be overcome by application of a pressurized fluid (e.g., air) from a supply source (not shown) to the piston 370. In particular, the pressurized fluid is delivered through the central opening 418 in the cover 414 and through the first bore 320 of the main body 306, so that it impacts the upper flange 378 of the piston 370. For example, one or more hoses and/or fittings (not shown) may be used to connect or otherwise interface the supply source of the pressurized fluid to the texturizing device 300.

The force of the pressurized fluid (pressing on the upper flange 378 of the piston 370) is sufficient to push the piston 370 down within the inner cavity 322 so as to compress the compression spring 386. As a result, the shaft 372 of the piston 370 moves downward through the central opening 402 in the seal holder 390, which causes the nose 374 of the piston 370 to enter the first passage 310 and trap the strand material therein (e.g., against a wall of the first passage 310). In this manner, continued application of the pressurized fluid is operable to prevent movement of the strand material through the passages 310, 338.

Furthermore, because the shaft 372 of the piston 370 is sized to essentially seal the first passage 310, when the piston 370 is pressing down on the strand material, the likelihood of air flowing back through the first passage 310 (e.g., from a cutting device of the texturizing device 300) is reduced or prevented. In this manner, disengagement or disruption of the strand material in the first passage 310 is avoided.

If application of the pressurized fluid is stopped or otherwise interrupted, the compression spring 386 will return to its normal, relaxed state. As the compression spring 386 relaxes, it pushes on the lower flange 376 of the piston 370. As a result, the shaft 372 of the piston 370 moves upward through the central opening 402 in the seal holder 390, which causes the nose 374 of the piston 370 to exit the first passage 310 thereby freeing the strand material to resume its movement through the passages 310, 338.

Thus, by controlling application of the pressurized fluid, the locking device 368 of the texturizing device 300 can selectively halt movement of the strand material through the passages 310, 338, such as between filling operations or other use cycles.

Proper operation of the locking device 368, however, may be compromised if dirt, debris, contaminants, or the like enter the inner nozzle section 302 (i.e., the inner cavity 322 of the main body 306) of the texturizing device 300. For example, broken glass filaments or particles are likely to be present in the first passage 310 on occasion. Because the glass filaments typically include a size applied thereto, this debris may become sticky, gummy, or the like (e.g., from application of elevated temperatures) such that it adheres to surfaces within the texturizing device 300 and is not readily displaced. Also, moisture may form within or otherwise enter the first passage 310.

Since the first passage 310 is connected to the inner cavity 322 of the main body 306 by virtue of the opening 324 formed in the floor of the inner cavity 322, any debris in the first passage 310 is liable to enter the inner cavity 322 where it poses a risk to effective operation of the locking device 368. In particular, if the debris enters the inner cavity 322, it can cause (e.g., by the debris itself or a buildup of such occurring over time) the locking device 368 to cease working, to work less efficiently, to require more maintenance than usual, etc. Furthermore, as a result of these efficiency losses, costs are increased.

Accordingly, as noted above, the texturizing device 300 includes a seal holder 390 for securing a sealing member (i.e., the O-ring 408) in the inner cavity 322 of the main body 306. In particular, the O-ring 408 is situated near the opening 324 in the floor of the inner cavity 322 (see FIG. 3D). The seal holder 390 is secured to the main body 306, as described herein, to insure the O-ring 408 stays in place. The O-ring 408 works in conjunction with the piston 370 (i.e., the shaft 372 and/or the nose 374 of the piston 370) to keep debris from entering the inner cavity 322 through the opening 324. Indeed, the O-ring 408 functions to keep debris out of the inner cavity 322, even when the texturizing device 300 is idle (i.e., not being operated).

The O-ring 408 may be made of any material suitable to keep the debris from passing from the first passage 310 into the inner cavity 322. In one exemplary embodiment, the O-ring 408 is made of rubber. In one exemplary embodiment, the O-ring 408 is made of polyurethane. Oil or other materials and/or substances made be added to the O-ring 408 to increase its efficiency (e.g., enhance its sealing capability, prolong its usable life).

Furthermore, the texturizing device 300 facilitates maintenance and/or necessary repair of the components (i.e., the piston 370; the spring 386; the O-rings 382, 408, and 422; and the seal holder 390) of the locking device 368. In particular, the cover 414 is readily removable from the main body 306 of the inner nozzle section 302, such that the components can be readily accessed so that any necessary repair or replacement can be carried out in a timely manner. This insures that any downtime (i.e., the time in which the texturizing device 300 cannot be used) is minimized.

In a manual process, a user may manipulate the apparatus 100/200 to place, discharge, or otherwise dispose the texturized strand material at a desired location. For example, in the context of road creation, the desired location might be a width of the roadway; in the context of road expansion, the desired location might be the expanded portion and/or the junction joining the old portion and the new portion; and in the context of road repair, the desired location might be a crack to be filled. The manual process can provide the user with the freedom to concentrate the texturized strand material on a preferred region of the road.

In an automated process, a machine (e.g., a vehicle) may manipulate the apparatus 100/200 to place, discharge, or otherwise dispose the texturized strand material at the desired location. In some exemplary embodiments, the automated process may involve the use of many of the apparatuses 100/200 working in parallel, with appropriate control logic to handle the simultaneous deposition of the texturized strand material. In this case, the control logic could control the individual deposition units 100/200 to ensure a uniform areal mass of the texturized strand material is deposited even if the road turns, becomes narrower, becomes wider, or becomes unlevel. In this case, the control logic could also adapt the deposition process based on changing road conditions by starting and/or stopping one or more of the individual units 100/200. In some exemplary embodiments, if a sensor detects a disruption in the deposition process (e.g., a failure of one or more of the units 100/200), the control logic can halt the machine for repair to ensure that the proper quantity of the texturized strand material is applied, according to the road structure specifications.

In some exemplary embodiments, multiple units 100/200 are installed on a vehicle. In some exemplary embodiments, multiple units 100/200 are adapted to be interfaced with (e.g., pulled by) a vehicle. In some exemplary embodiments, the vehicle (or related equipment) includes a device for applying a binder (e.g., a bituminous substance) before, during, and/or after deposition of the texturized strand material. In some exemplary embodiments, the control logic is directly connected to the units 100/200. In some exemplary embodiments, the control logic is indirectly connected (e.g., via a wireless network) to the units 100/200.

As noted above, the present invention encompasses an apparatus (e.g., the apparatuses 100, 200) for applying a texturized strand material for use in building or repairing roads or similar surfaces. The texturized strand material deposited by the apparatus will comprise continuous fibers (e.g., many meters long) or fibers that are chopped (e.g., using the cutter of the texturizing device 300) to a relatively long length (e.g., greater than 0.5 meters). The texturized strand material will typically have a density in the range of 40 g/L to 300 g/L, or in some cases 80 g/L to 160 g/L. The texturized strand material represents a volumized collection of fiber filaments that have been expanded. In the case of no texturization, the strand material has a width in the range of 2 mm to 10 mm, while the texturization process (as described above) causes the strand material to exit the apparatus as a volumized bundle of fibers having a tape-like shape with a width in the range of 30 mm to 200 mm.

For reinforcement applications, it is important that an effective quantity of the reinforcement material (e.g., the texturized strand material) be adequately distributed on the roadway. In some exemplary embodiments, the apparatus (e.g., the apparatuses 100, 200) apply from 10 g/m² to 150 g/m² of the texturized strand material to the area being reinforced. In some exemplary embodiments, the apparatus (e.g., the apparatuses 100, 200) apply from 20 g/m² to 60 g/m² of the texturized strand material to the area being reinforced.

In some instances, it may be sufficient to simply apply the texturized strand material in its native form without any particular deposition pattern or corresponding manipulation (e.g., oscillation) of the fiber stream. Thus, the random placement of the texturized strand material could serve its intended reinforcement/repair purpose. For example, filling a small hole in a roadway might be one such case. In general, depending on the intended reinforcement application (e.g., the type of repair being performed), the constraints applied on the material being used, and the width of the support to be treated, the texturized strand material may be deposited according to different geometrical parameters.

Typically, however, it will be beneficial to apply the texturized strand material in a more complex pattern, such as a Z-shaped or S-shaped deposition pattern. There are many parameters that can impact the deposition process and, thus, the deposition pattern. In particular, the throughput of the texturizing device (e.g., the texturizing device 102), the width of the texturized strand material, and the targeted quantity of the texturized strand material to be applied (in g/m²) are all important variables in the deposition process. Furthermore, the desired deposition angle depends on the type of reinforcement or repair (e.g., crack arrestment) to be achieved. In the case of an automated deposition process, the speed of the application vehicle is another parameter that should be considered. The general inventive concepts contemplate that the inversion frequency of the oscillating mechanism (e.g., the oscillator 106) is adjusted based on one or more of these parameters.

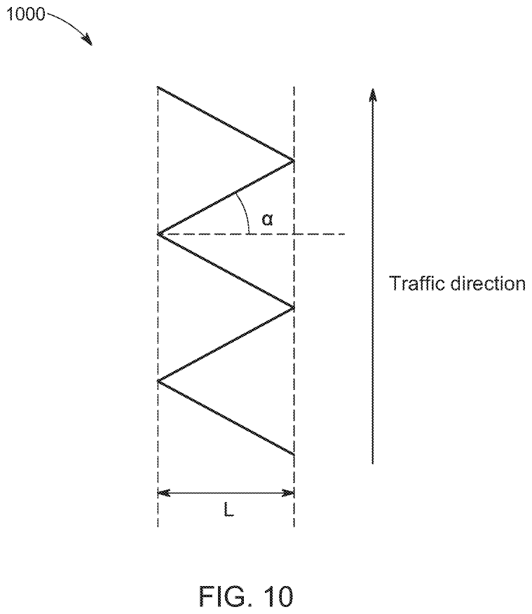

For example, the case 1000 of a single deposition path with a variable angle will be described with reference to FIG. 10. In this case 1000, if cracks or mechanical stress are in the direction of the traffic, the angle α can be in the range of 5 degrees to 40 degrees. Alternatively, if the cracks or mechanical stress are across the direction of the traffic, the angle α may be over 40 degrees. To maintain a constant deposition width L, the inversion frequency to the deposition direction must be adapted as a function of the deposition angle α. To provide an effective and economically advantageous reinforcement, a single deposition of the texturized strand material may suffice, for example, to treat a lengthwise cracking or a joint area between two parallel layers on a road.

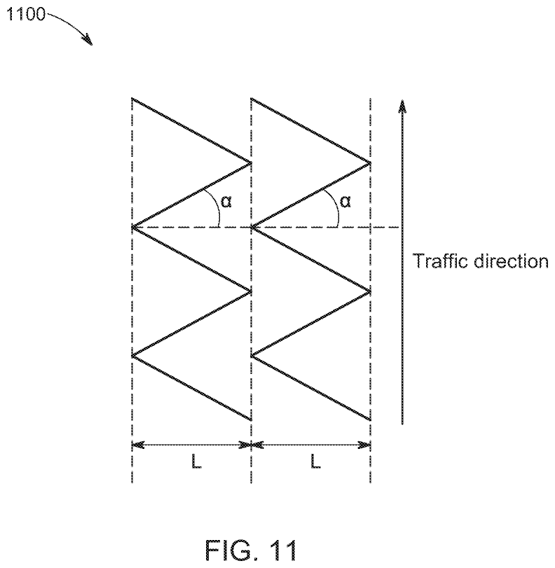

The case 1100 of two parallel deposition paths (rows) each having a width L with no overlap and no dephasing will be described with reference to FIG. 11. In this case 1100, if the reinforcement application requires the treatment of an entire road surface (e.g., to repair multiple cracks or ensure a good mechanical resistance for the whole surface), several deposition shapes may be used. For the treatment of an entire road, the number of rows can be multiplied up to the global road width or the capability of the application apparatus. An advantage of this approach is that it allows for application of a relatively low quantity of fibers per square meter, which provides economic benefits. However, a drawback of this approach is the risk of cracks forming between adjacent rows and being propagated in the traffic direction.

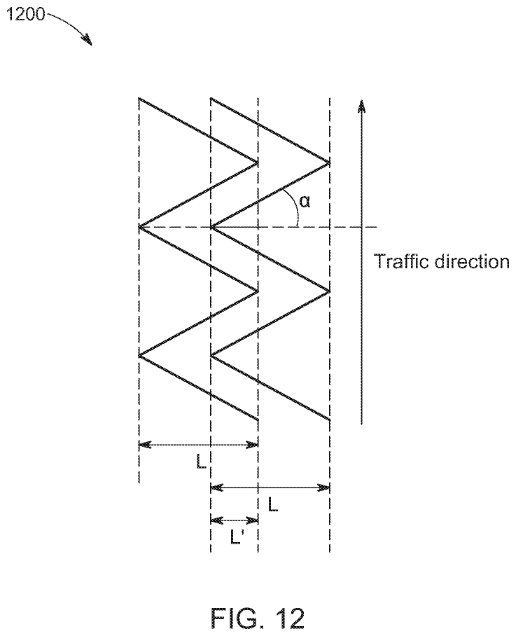

The case 1200 of two parallel deposition paths (rows) each having a width L with an overlapping width of L′ and no dephasing will be described with reference to FIG. 12. In this case 1200, for the treatment of an entire road, the number of rows can be multiplied up to the global road width or the capability of the application apparatus. An advantage of this approach is that it provides a better covering of the treated surface than the case 1100. The overlap width L′ can be used in a function relating mechanical performances of the road (initial and aging). Furthermore, from a cost perspective, the overlap width L′ is a parameter that can be adjusted to control the quantity of applied fibers per square meter (with a cost increase for this case dependent on the ratio L′/L). Although an improved mechanical resistance is expected with this configuration (than in the case 1100), there is still a risk of non-linear crack formation between adjacent rows.

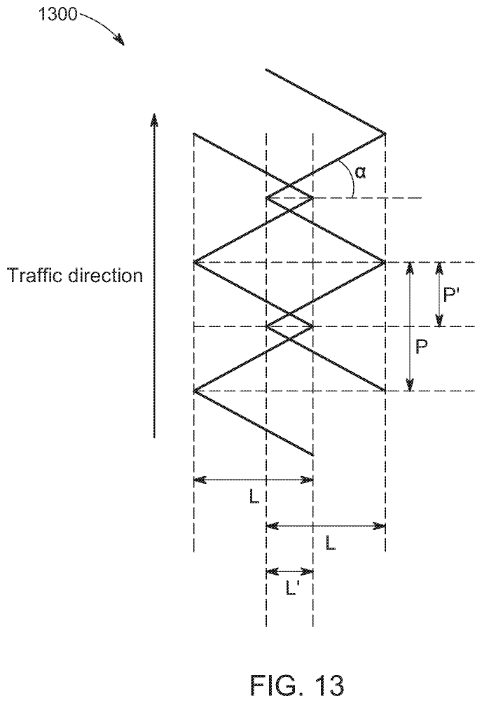

The case 1300 of two parallel deposition paths (rows) each having a width L with an overlapping width of L′ and dephasing of P′ will be described with reference to FIG. 13. In this case 1300, for the treatment of an entire road, the number of rows can be multiplied up to the global road width or the capability of the application apparatus. The covering of this approach is globally equivalent to the case 1200. Again, the overlap width L′ is a parameter that can be adjusted to control the quantity of applied fibers per square meter. The dephasing distance P′ (with P′ preferably being ½ of the deposition phase P) greatly limits crack propagation without crossing a transverse fiber reinforced area. A more effective mechanical resistance and aging benefit is expected with this network configuration. In some exemplary embodiments, the dephasing is readily obtained in an automated deposition process by positioning adjacent applicators (e.g., apparatus 100/200) so that their respective nozzles are offset from one another by the distance P′.

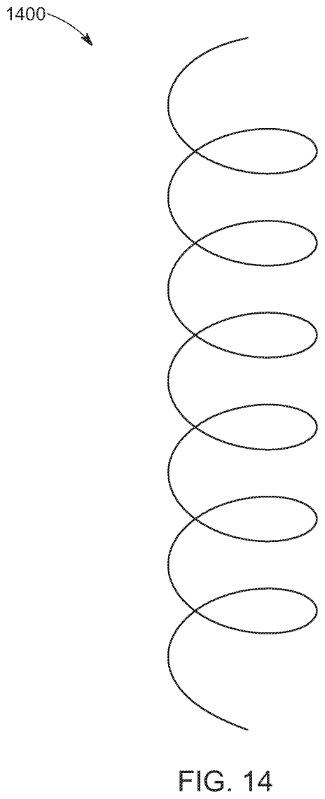

Although the examples shown in FIGS. 10-13 illustrate a Z-shaped deposition pattern, other deposition patterns are encompassed by the general inventive concepts. For example, as shown in FIG. 14, a corkscrew deposition pattern 1400 can be produced by an apparatus (e.g., the apparatus 100) wherein an angled output opening (e.g., the output opening 110) of the apparatus is mounted on a ball bearing and caused to rotate around its main axis during deposition of a reinforcement material (e.g., the texturized strand material).

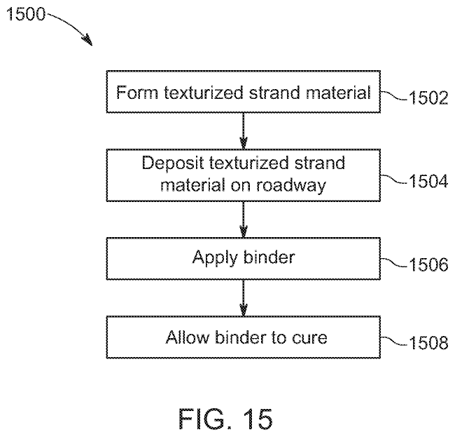

A method 1500 of reinforcing a road, according to an exemplary embodiment, will be described with reference to FIG. 15. In the method 1500, a pressurized fluid is used to volumize a strand of reinforcing filaments to form a texturized strand material, at step 1502. Typically, formation of the texturized strand material occurs on site (i.e., at the time of application). In some exemplary embodiments, the pressurized fluid is compressed air. In some exemplary embodiments, the reinforcing filaments are glass filaments. In some exemplary embodiments, the strand of reinforcing filaments includes at least 1,000 individual glass filaments. In some exemplary embodiments, the texturized strand material has a density within the range of 40 g/L to 300 g/L. In some exemplary embodiments, the texturized strand material has a density within the range of 80 g/L to 160 g/L.

According to the method 1500, a continuous length of the texturized strand material is deposited on at least a portion of the road, as step 1504. In some exemplary embodiments, the length is at least 0.5 meters. In some exemplary embodiments, the length is greater than 1 meter. A binder is applied to the portion of the road as well, at step 1506. In some exemplary embodiments, the binder is applied prior to deposition of the texturized strand material. An advantage of this approach is that the sticky nature of the binder can keep the texturized strand material from becoming displaced (e.g., by a heavy wind). In some exemplary embodiments, the binder is applied during deposition of the texturized strand material. In some exemplary embodiments, the binder is applied after deposition of the texturized strand material. In some exemplary embodiments, the binder is applied both before and after deposition of the texturized strand material. In some exemplary embodiments, the binder is applied before, during, and after deposition of the texturized strand material. Typically, the binder will encapsulate the entire volume of the texturized strand material. In some exemplary embodiments, the binder is asphalt. Finally, the binder is cured or otherwise allowed to set at step 1508. Thereafter, the reinforcement or repair may be complete, or additional processing on the road (e.g., introduction of additional layers, coats) may take place.

Typically, the binder will be a bituminous binder or asphalt. In general, the binder can be applied as hot asphalt or as an emulsion of asphalt. In the case of hot asphalt, the fluidity of the binder is regulated by its temperature and “hardening” of the binder occurs during cooling thereof. In the case of an asphalt emulsion, the fluidity of the binder is obtained by the presence of water (and surfactants) in the emulsion. To obtain “hardening,” the emulsion must break (for example, by adding a small quantity of cement in the case of a cationic emulsion) to separate the water and asphalt. When the emulsion breaks, two distinct phases appear: water and asphalt. Then, as the water is removed (e.g., through runoff, evaporation), the remaining asphalt solidifies. More specifically, the agglomeration of the asphalt particles (sedimentation) induces a viscosity increase in the asphalt phase. It can take a relatively long period of time (e.g., days, weeks, months) for the final properties of the bituminous product to be realized. Consequently, a problem can arise early on in degradation of the bituminous product of such emulsions, mainly when exposed to heavy loads (e.g., trucks traveling over the product) at this time. An advantage of the glass fiber reinforcement is it mitigates against such degradation.

In some exemplary embodiments, the step of depositing the texturized strand material on the road (step 1504) further comprises depositing both a first length of the texturized strand material and a second length of the texturized strand material in a direction that is substantially parallel to a lengthwise direction of the road (i.e., a direction in which traffic is intended to travel on the road). The first length of the texturized strand material is deposited in a non-linear manner covering a first width, wherein the first length of the texturized strand material travels from one side of the first width to the other in a repeating manner. Each repeating portion of the first length of the texturized strand material that extends across the first width constitutes a leg of the first length, wherein each leg of the first length forms a first angle with an axis extending perpendicular to the lengthwise direction of the road. The first angle will generally be greater than 0 degrees and less than 90 degrees. In some exemplary embodiments, the first angle is within the range of 5 degrees to 40 degrees. In some exemplary embodiments, the first angle is within the range of 40 degrees to 85 degrees.

The second length of the texturized strand material is deposited in a non-linear manner covering a second width, wherein the second length of the texturized strand material travels from one side of the second width to the other in a repeating manner. Each repeating portion of the second length of the texturized strand material that extends across the second width constitutes a leg of the second length, wherein each leg of the second length forms a second angle with an axis extending perpendicular to the lengthwise direction of the road. The second angle will generally be greater than 0 degrees and less than 90 degrees. In some exemplary embodiments, the second angle is within the range of 5 degrees to 40 degrees. In some exemplary embodiments, the second angle is within the range of 40 degrees to 85 degrees.

The first width is less than the width of the road (or the portion of the road) being reinforced. The second width is less than the width of the road (or the portion of the road) being reinforced. In some exemplary embodiments, the combination of the first width and the second width equals the width of the road (or the portion of the road) being reinforced.

The first length and the first width define a first area (i.e., first row) in which the texturized strand material is deposited. The second length and the second width define a second area (i.e., second row) in which the texturized strand material is deposited. In some exemplary embodiments, a number of rows of the texturized strand material are deposited to equal the area of the road (or the portion of the road) to be reinforced.

In some exemplary embodiments, the dimensions of each row (i.e., the area being covered by deposition of the texturized strand material) are the same. As noted above, each row could be applied by the same apparatus making sequential passes or by multiple apparatuses arranged to work in parallel.

In some exemplary embodiments, the first row and the second row are approximately the same size, are adjacent to one another, and do not overlap.

In some exemplary embodiments, the first row and the second row are approximately the same size, are adjacent to one another, and overlap by a portion having a third width, wherein the third width is less than the first/second width, as shown in FIG. 12.

In some cases where the first row and the second row are approximately the same size and overlap one another, the first length of the texturized strand material and the second length of the texturized strand material are in phase within their respective rows (i.e., not offset from one another in the lengthwise direction), as shown in FIG. 12. Consequently, the first length of the texturized strand material and the second length of the texturized strand material do not touch one another in the overlapping portion.

In some cases where the first row and the second row are approximately the same size and overlap one another, the first length of the texturized strand material and the second length of the texturized strand material are not in phase with one another within their respective rows (i.e., are offset from one another in the lengthwise direction), as shown in FIG. 13. Consequently, the first length of the texturized strand material and the second length of the texturized strand material cross one another in the overlapping portion. In some exemplary embodiments, the difference in phase between the first length of the texturized strand material and the second length of the texturized strand material is approximately ½ the length of a leg of the first or second length.

Various exemplary embodiments are described above that involve texturizing a direct roving (e.g., single glass fiber bundle having 2,000 to 9,600 filaments in the bundle and a weight up to 7,000 tex). The roving is texturized to obtain “individual filamentization” and then applied to the desired area (e.g., on a roadway). However, in some exemplary embodiments, the reinforcement material does not require texturization to be an effective reinforcement for roads and other similar applications. For example, relatively thin, continuous filament glass fibers can be used as the reinforcement material. More specifically, multiple thin fibers, each having from 100 to 800 individual filaments, can be used as the reinforcement material. The filaments making up such a thin fiber have an average diameter in the range of 9 μm to 24 μm. Each thin fiber has a linear density of 30 tex to 300 tex. These thin fibers are assembled in a multi-end roving (MER) comprising up to 64 separate fibers and having a weight up to 9,000 tex.

During application, the fibers are randomly deposited on a road surface to be reinforced, such that the fibers cross one another. Because of the strong strand integrity imparted to each of the fibers by the chemical sizing applied thereto, the fibers generally tend to maintain their form (i.e., are not texturized) during application on the roadway. This product form can be used to cover the same surface as the previously described embodiments (although with more space between the reinforcing elements than with texturized products). In some exemplary embodiments, from 10 g/m² to 150 g/m² of the fibers are applied to the area being reinforced. In some exemplary embodiments, from 20 g/m² to 60 g/m² of the fibers are applied to the area being reinforced.

While the reinforcing performance of the thin fibers may be slightly less than in the case of the texturized strand material, the thin fibers nonetheless perform adequately in many similar reinforcing applications. Furthermore, use of thin fibers as the reinforcement material can give rise to advantages including a higher wetting speed with the (bituminous) binder and less sensitivity to external/environmental conditions like moisture content, temperature, wind, etc.

The above description of specific embodiments has been given by way of example. From the disclosure given, those skilled in the art will not only understand the general inventive concepts and their attendant advantages, but will also find apparent various changes and modifications to the structures and concepts disclosed. For example, although the exemplary embodiments described herein are directed to reinforcing a road, the invention is able to reinforce similar structures such as parking lots, runways, cycle paths, and the like. It is sought, therefore, to cover all such changes and modifications.

1. An apparatus comprising:
a body including a texturizing device having an input opening and an output opening;
a nozzle interfaced with the output opening;
an oscillator; and
a screen,
wherein the texturizing device is operable to convert a strand of fibrous material fed through the input opening into a texturized fibrous material upon exiting through the nozzle,
wherein the oscillator is operable to rotate the nozzle such that the texturized fibrous material is deposited in a predetermined pattern, and
wherein the screen is positioned to be in the path of the nozzle such that the texturized fibrous material impacts the screen.

2-11. (canceled)

12. The apparatus of claim 1, wherein the body further comprises a handle for holding the apparatus.

13. The apparatus of claim 1, wherein the body further comprises a mount for mounting the apparatus to an automated applicator.

14. The apparatus of claim 13, wherein the automated applicator is an industrial robot.

15. The apparatus of claim 1, wherein the body further comprises a mount for mounting the apparatus to a vehicle.

16. The apparatus of claim 1, wherein the screen is fixed to the body.

17. The apparatus of claim 16, wherein the screen has a plurality of perforations therein.

18. The apparatus of claim 1, wherein the screen is fixed to the nozzle and rotates with the nozzle.

19. The apparatus of claim 18, wherein the screen has a plurality of perforations therein.

20. The apparatus of claim 1, wherein the input opening and the output opening are coaxial with one another about an axis x, and
wherein the texturized fibrous material exits the nozzle at an angle θ relative to the axis x.

21. The apparatus of claim 20, wherein |θ|>15 degrees.

22. The apparatus of claim 20, wherein |θ|>30 degrees.

23. The apparatus of claim 1, further comprising first logic for controlling the oscillator.

24. The apparatus of claim 23, wherein the first logic causes the oscillator to rotate in at least one of a clockwise direction and a counterclockwise direction.

25. The apparatus of claim 24, wherein the first logic controls a ratio of clockwise rotations of the nozzle to counterclockwise rotations of the nozzle.

26. The apparatus of claim 23, wherein the first logic varies a frequency at which the oscillator rotates the nozzle.

27. The apparatus of claim 23, wherein the first logic varies an amplitude at which the oscillator rotates the nozzle.

28. The apparatus of claim 23, further comprising second logic for controlling a rate at which the fibrous material travels through the texturizing device.

29. The apparatus of claim 28, wherein the second logic varies the rate to achieve the pattern.

30. The apparatus of claim 28, further comprising a source of compressed air for converting the strand of fibrous material to the texturized fibrous material; and
third logic for controlling a pressure of the compressed air,
wherein the third logic varies the pressure to achieve the pattern.

31-55. (canceled)
